(19) United States
(12) Patent Application Publication
(10) Pub. No.: US 2004/0193491 A1
(43) Pub. Date: Sep. 30, 2004

(54) Systems and methods for promoting savings through a computer-enabled certificate program

(76) Inventor: Peter Davis, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/808,107

(22) Filed: Mar. 24, 2004

Related U.S. Application Data
(60) Provisional application No. 60/457,501, filed on Mar. 24, 2003.

(51) Int. Cl. G06F 17/60

(52) U.S. Cl. 705/14; 705/35; 705/36; 705/37

(57) ABSTRACT

Methods for promoting savings through a computer-enabled certificate program are provided. An exemplary method comprises the steps of: purchasing a certificate; issuing the certificate, wherein the certificate is transmitted to a recipient; redeeming the certificate for a monetary value; and directing the monetary value to a savings vehicle, wherein the savings vehicle is selected by the recipient. Systems are also provided.

### CROSS-REFERENCE TO RELATED APPLICATION

This application claims priority to copending U.S. provisional application entitled, “EDUCATION CERTIFICATE BUSINESS CASE,” having Ser. No. 60/457,501, filed Mar. 24, 2003, which is entirely incorporated herein by reference.

### TECHNICAL FIELD

The present invention is generally related to computer-enabled tools and techniques for promoting consumer savings and, more particularly, is related to systems and methods for consumers to direct cash or convert award or loyalty points for deposit into a savings vehicle or as a contribution to a charitable or other organization.

### DESCRIPTION OF THE RELATED ART

Consumers who wish to place part of their hard-earned money in savings accounts face psychological hurdles, in addition to the inherent economic hurdles. It is difficult to set aside funds for savings when so many other uses compete for those funds, and even more difficult to do so consistently. This personal savings deficiency trickles down to a savings crisis at our nation's non-profit organizations as many families do not have the disposable income to donate. At the same time that consumers and organizations are not saving enough money, many are accruing savings of tens or hundreds of thousands of loyalty points through a myriad of air mile or other loyalty rewards programs.

Some existing programs facilitate the redemption of points and miles for the purchase of merchandise or donations to charity. One such program, Gold Points®, allows the use of points for the purchase of merchandise from certain catalogs, such as the Gold Points® catalog and the Sky Mall® catalog. Another program, TruCash®, enables users to redeem their earned points for use at a number of on-line and offline partners, for donation to the charity of their choice, or for a cash rebate in the form of a check. Through a program operated by Trilegiant Loyalty Solutions (TLS), members are able to convert loyalty points at set redemption levels in exchange for donations to any one of a list of client-selected charities. In addition, similar programs allow the conversion of earned flyer miles into a donation to charity. For instance, MileDonor.com facilitates the donation of miles, points and awards for personal and charitable use worldwide.

Another on-line gift certificate program is SaveDaily®. Through the SaveDaily® program individuals can send gift certificates of any amount over $25 to the recipient of their choice. The funds purchased for the certificate are directed to an escrow account until the recipient accepts disbursement of the funds to his or her account. The recipient is instructed to visit the SaveDaily® website to redeem their gift certificate for mutual fund shares, invested on their behalf. The SaveDaily® gift certificate program offers recipients only one choice in the redemption of their certificates: to invest the funds in a mutual fund opened from the SaveDaily® website. Gift certificate recipients are not at liberty to contribute the funds to any savings vehicle (college savings account, retirement account, mutual fund, non-profit organization, etc.) at any financial institution. Thus the redemption opportunities of the SaveDaily® certificate are limited. Additionally, the SaveDaily® gift certificates can solely be purchased on-line using a credit card.

Other examples of somewhat similar programs include state 529 plan gift certificates, such as those offered in Florida, called the Florida College Investment Plan Gift Certificate. Once again, the 529 plan gift certificates are limited. The Florida College Investment Plan gift certificate can be purchased only by mailing a check or money order and contribution coupon, and the certificate is valid only for contribution to an existing Florida College Investment Plan. The range of purchase and redemption options is narrowly limited.

### SUMMARY

Systems and methods for promoting savings through a computer-enabled certificate program are provided. An exemplary embodiment of such a system includes a computer-readable medium having a computer program for implementing a certificate program, where the computer program performs the steps of: receiving an order to purchase a certificate, wherein the certificate comprises a specific value; processing the order to purchase the certificate; issuing the certificate; redeeming the certificate; and depositing the specific value into an account.

An embodiment of a method can be broadly summarized by the following steps: marketing the certificate program; receiving a purchase request for a certificate; processing the purchase request for the certificate; issuing the certificate; and redeeming the certificate.

Other systems, methods, features and/or advantages will be or may become apparent to one with skill in the art upon examination of the following drawings and detailed description.

### BRIEF DESCRIPTION OF THE DRAWINGS

The components in the drawings are not necessarily to scale. Moreover, in the drawings, like reference numerals designate corresponding parts throughout the several views.

FIG. 1 is block diagram of an embodiment of a reward and redemption certificate program

FIG. 2 is a block diagram illustrating representative embodiments of certificate forms.

FIG. 3 is a block diagram illustrating an embodiment of a certificate issuer system.

FIG. 4 is a block diagram illustrating representative embodiments of certificate program marketing options.

FIG. 5 is a block diagram illustrating an embodiment certificate purchase processing.

FIG. 6 is a block diagram illustrating an embodiment of purchasing a certificate using loyalty points.

FIG. 7 is a block diagram illustrating an embodiment of a certificate issue process.

FIG. 8 is a block diagram illustrating an embodiment of a certificate redemption process.

FIG. 9 is a sample screen of an embodiment of on-line redemption payout options.

FIG. 10 is a sample screen of an embodiment of on-line redemption account selection.

FIG. 11 is a sample screen of an embodiment of on-line redemption savings plan selection.

FIG. 12 is a sample screen of an embodiment of on-line redemption plan information entry.

FIG. 13 is a block diagram of an embodiment of an on-line certificate redemption process.

### DETAILED DESCRIPTION

It is noted that the drawings presented herein have been provided to illustrate certain features of selected embodiments. It will be appreciated from the description provided herein that a variety of alternative embodiments and implementations may be realized.

As summarized above, systems and methods for promoting savings through use of a computer-enabled certificate program are provided. It should be appreciated that the term certificate broadly defines an instrument which may include a gift certificate, a savings certificate, an award certificate, a voucher, a coupon, or a unique number or other identifier.

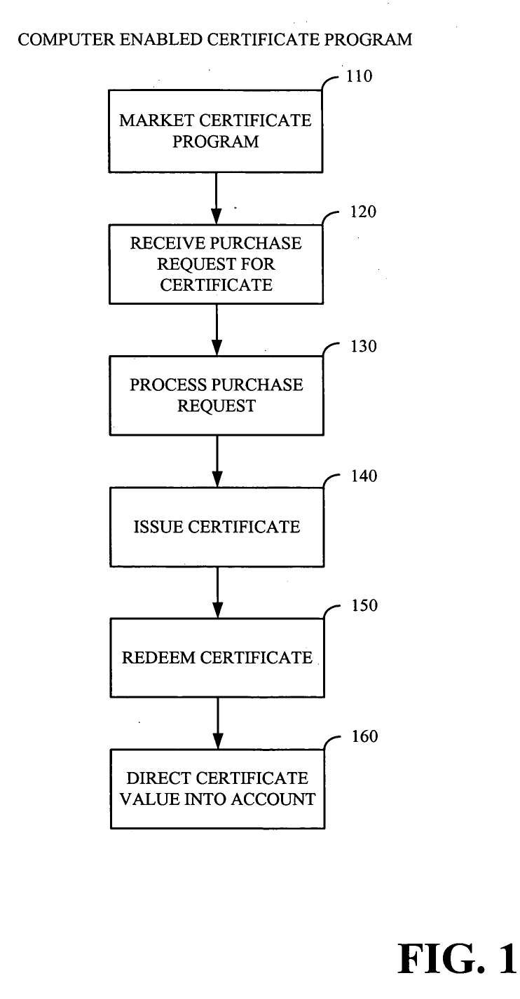

Reference is made briefly to FIG. 1, which illustrates an embodiment of a system for promoting savings through use of a computer-enabled certificate program. As illustrated, this embodiment may contain a process to market the certificate program (block 110). The marketing step should have the effect of increasing consumer exposure to the certificate program and increasing participation in the certificate program. This embodiment of the certificate program includes steps for receiving a purchase request (block 120) and processing the purchase request (block 130). It should be appreciated that the receiving and processing steps may be performed within the same electronic data processing device or in separate electronic data processing devices where the separate devices are not necessarily in direct communication with each other. Additionally, this embodiment generally includes the step of issuing the certificate (block 140). After the certificate is issued, a recipient may then redeem the certificate (block 150) whereby the value of the certificate is directed into an account specified by the recipient (block 160).

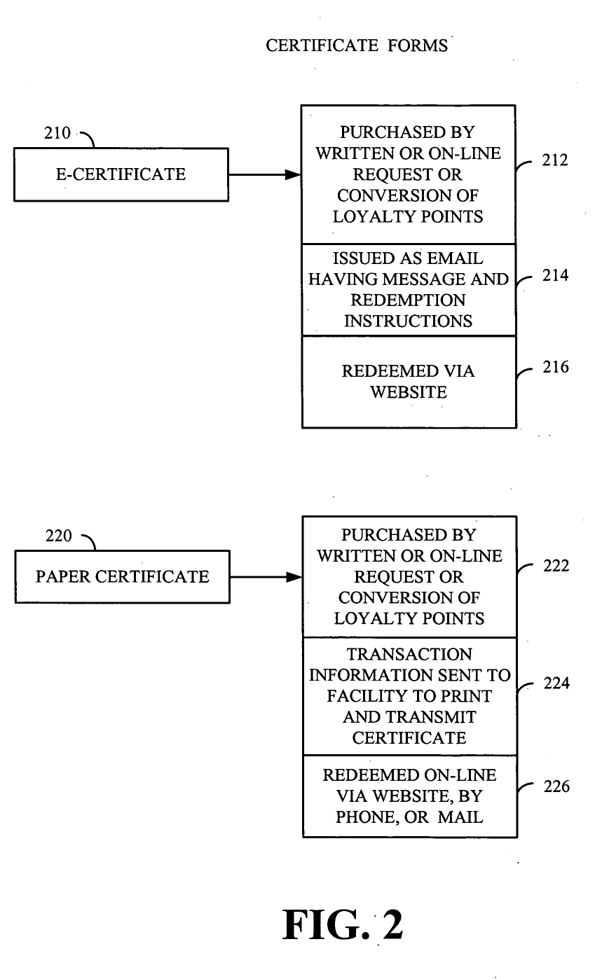

Reference is now made to FIG. 2, which illustrates representative forms in which a certificate can be issued. The certificate can be issued as an e-certificate (block 210), i.e. the certificate is issued electronically. For example, the certificate can be issued in an email (block 214). The e-certificate email of this embodiment includes, for example, a unique identifier or number, a welcome message and redemption instructions and data. The email of this embodiment also includes a link to a redemption website (block 216). The e-certificate can be purchased through a written, verbal, or on-line request or through the conversion of loyalty points or airline miles (block 212), as discussed below.

A certificate can also be issued in the form of a paper certificate (block 220). The paper certificate is purchased through a written or on-line request or through the conversion of loyalty points (block 222). Issuing the certificate is accomplished by sending the transaction information to a printing facility where the certificate is printed and transmitted to the recipient or consumer (block 224). The paper certificate is redeemed on-line at a website, by telephone, or by mail (block 226). The redemption information is provided with the gift certificate regardless of whether the form of the certificate is an e-certificate or a paper certificate.

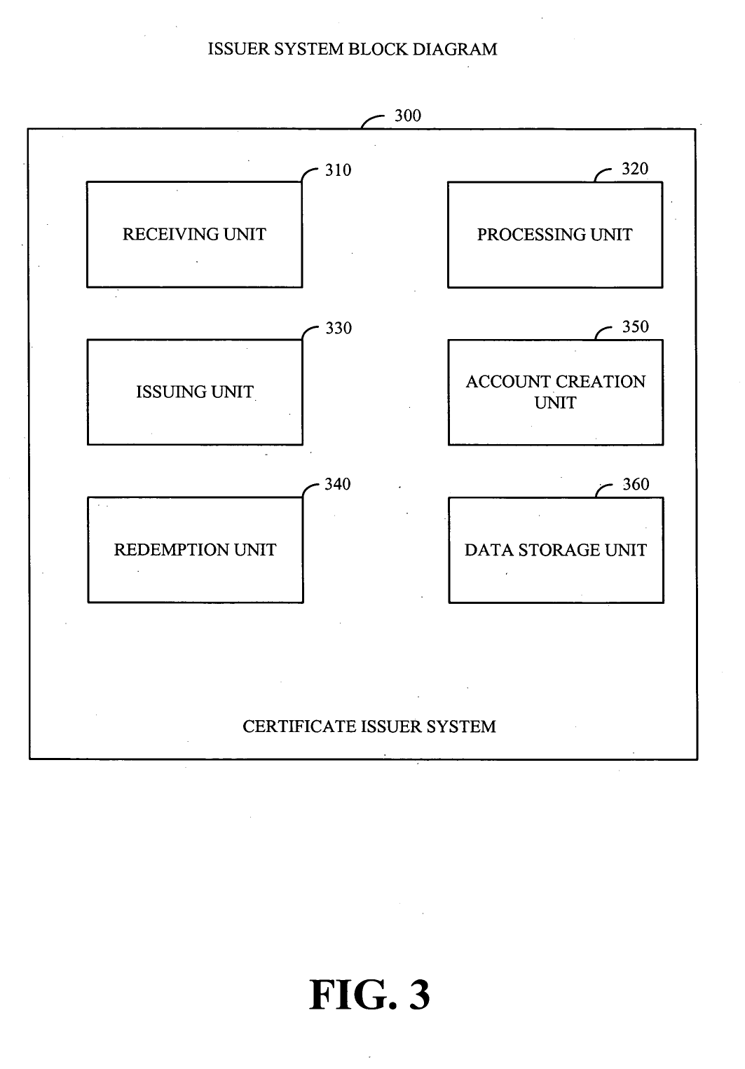

It should be appreciated that many configurations of computer and electronic data processing, storage and communication hardware and software may be configured to perform this embodiment. Reference is now made to FIG. 3, which illustrates the components of an embodiment of a certificate issuer system (block 300) that can be used for implementing a system for promoting savings through use of a computer-enabled certificate program. The certificate issuer system of this embodiment includes a receiving unit for receiving orders for certificates (block 310), a processing unit for processing the purchase orders and generating data records (block 320), and an issuing unit for issuing certificates (block 330). The certificate issuer system of this embodiment also includes a redemption unit for redeeming issued certificates (block 340). Additionally, the certificate issuer system of this embodiment includes an account creation unit for creating accounts for new users (block 350) and a data storage unit for storing the data in databases (block 360).

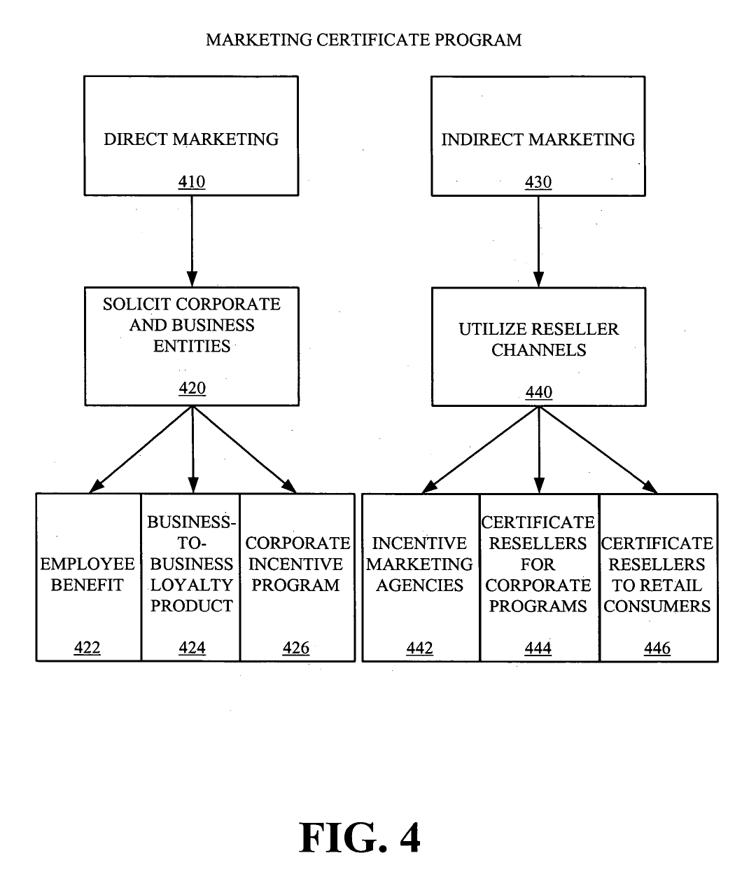

A block diagram illustrating marketing options in an embodiment of the certificate program is illustrated in FIG. 4. The two primary methods of marketing the certificate program are direct marketing (block 410), where corporate and business entities are solicited (block 420), and indirect marketing (block 430), where existing reseller channels are utilized (block 440). Direct marketing solicits corporate and business entities to participate in a certificate program for providing an employee benefit (block 422), a business-to-business loyalty product (block 424), or as a corporate incentive program (block 426). The reseller channels for indirect marketing include incentive marketing agencies (block 442), certificate resellers for corporate programs (block 444) and certificate resellers to retail consumers (block 446).

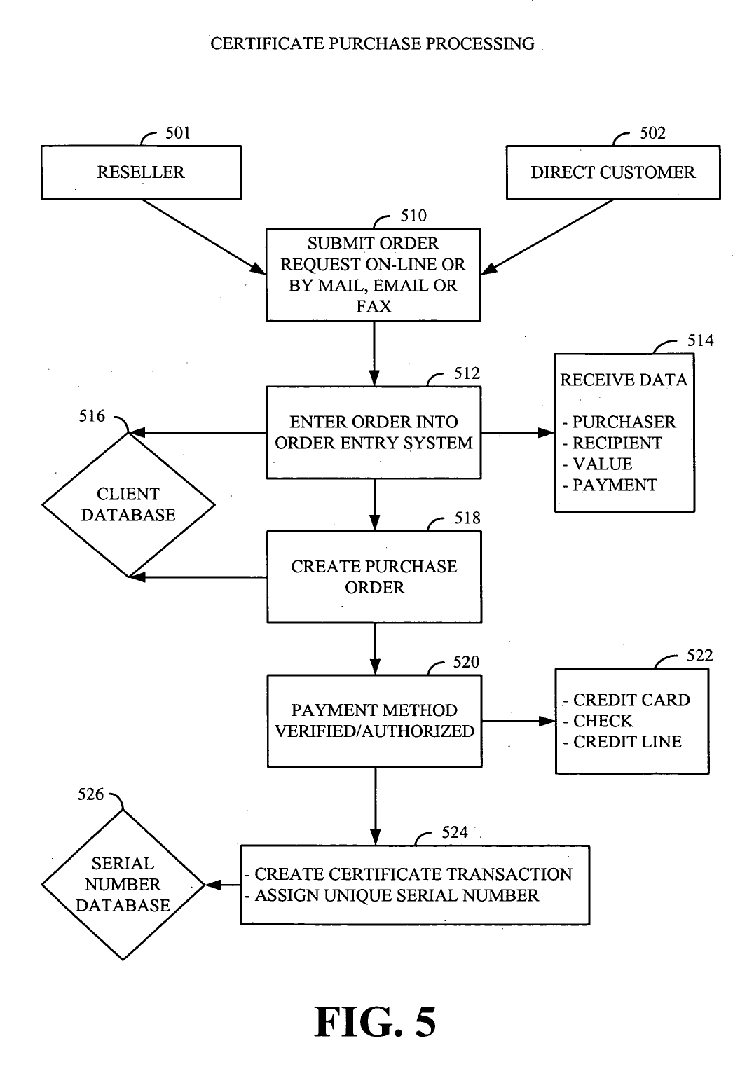

Reference is now made to FIG. 5, which illustrates an embodiment of the purchase processing sequence. The purchase process begins when a reseller (block 501) or a direct customer (block 502) submits an order request on-line or by mail, email or facsimile (block 510). The order is entered into an order entry system (block 512) and includes receiving data relating to the purchaser, the recipient, the certificate value and the payment information (block 514). Additionally, this data is entered into a client database (block 516). After entering the order, a purchase order is created (block 518) and also stored in the client database (block 516). The payment method is verified and authorized (block 520). Payment may, for example, be in the form of credit card, check or a pre-approved credit line (block 522). After authorization a certificate transaction is created and assigned a unique serial number (block 524). The unique serial number is entered into a serial number database (block 526).

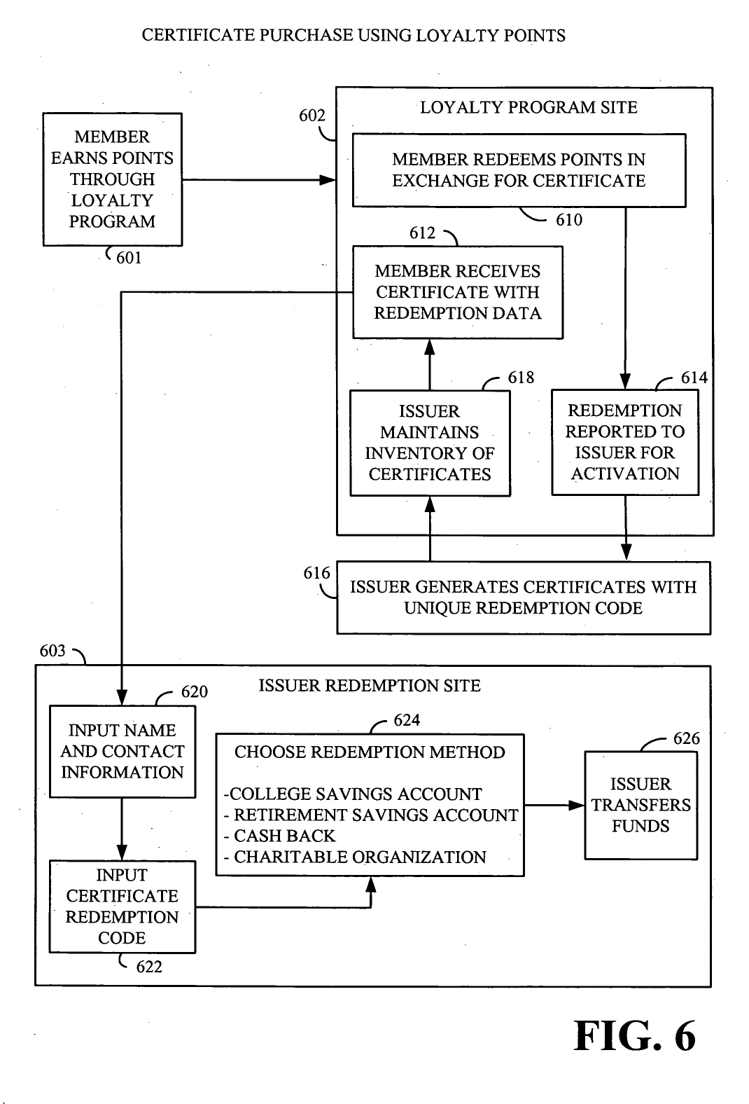

As shown in FIG. 6, an embodiment provides that a certificate purchase may be performed using loyalty points. After a member earns loyalty points through a loyalty program (block 601), the member contacts the loyalty program site (block 602) to redeem the points in exchange for a certificate (block 610). The redemption is reported to the issuer for activation (block 614). The issuer, who maintains an inventory of certificates (block 618), generates certificates having a unique redemption code (block 616). The member receives the certificate with the redemption data (block 612) and contacts the issuer redemption site (block 603). At the issuer redemption site, the member inputs their name and contact information (block 620) and the certificate redemption code (block 622). The member then selects a redemption method (block 624). The redemption methods in this embodiment include but are not limited to a college savings account, a retirement savings account, a US Savings Bond, a charitable organization and cash back. After the redemption method is selected, the issuer transfers the funds to the appropriate institution or individual (block 626).

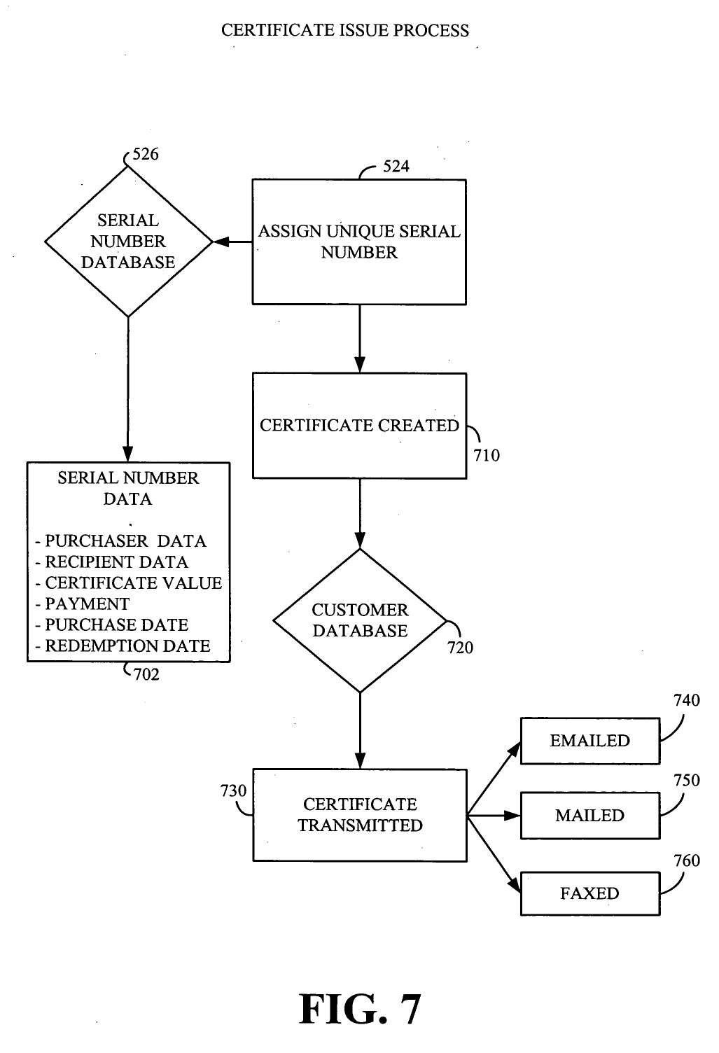

A block diagram of a certificate process in an embodiment is illustrated in FIG. 7. As discussed earlier, the certificate transaction is assigned a unique serial number and the serial number is stored in a serial number database. The serial number data includes but is not limited to content relating, for example, to purchaser data, recipient data, certificate value, payment data, purchase date and redemption date (block 702). The certificate is created using the unique serial number (block 710) and the data is transmitted to and stored in a customer database (block 720). After storing the information in a customer database the certificate is transmitted to the recipient (block 730) using email, mail or facsimile (blocks 740, 750 and 760).

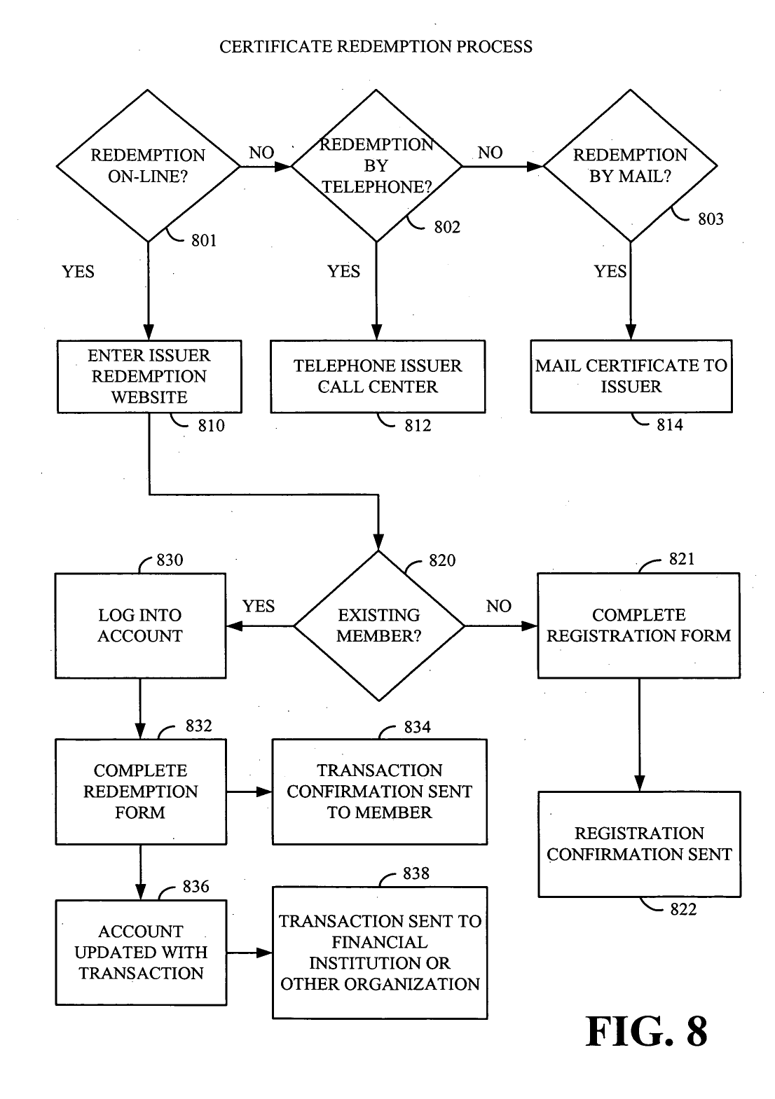

Reference is now made to FIG. 8, which illustrates an embodiment of a certificate redemption process. Certificate redemption can, for example, be accomplished on-line using the internet or other computer network (block 801), by telephone (block 802) or by physical delivery of the certificate such as through the mail (block 803). Redemption by mail requires the recipient to mail the certificate and redemption selection information to the issuer (block 814). Redemption by telephone is accomplished by calling an issuer approved call center to provide the certificate and redemption selection information (block 812). To redeem on-line, the recipient links to and enters an issuer approved redemption website (block 810).

After connecting to the issuer website, if the recipient is not an existing member (block 820) a registration form is completed (block 821). The registration confirmation is transmitted to the recipient to complete the registration process (block 822). Where the recipient is an existing member, the recipient will log into their account (block 830) and complete the redemption form (block 832). A transaction confirmation is sent to the member recipient (block 834), the member account is updated with the transaction (block 836), and the transaction information and proceeds are sent to the appropriate financial institution, organization or individual (block 838).

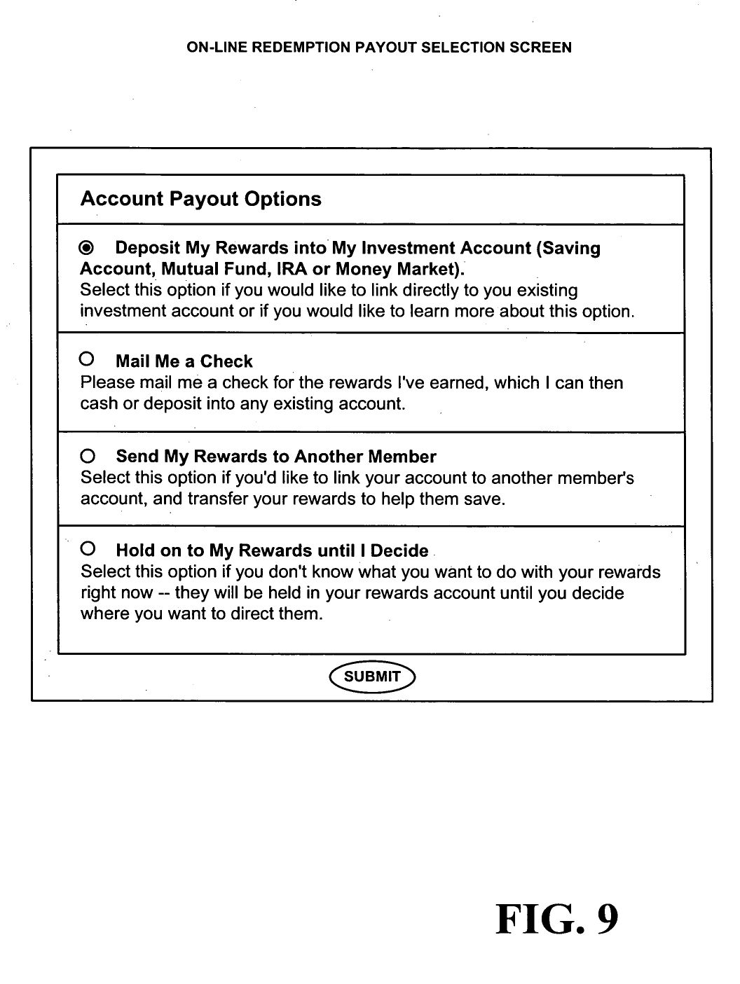

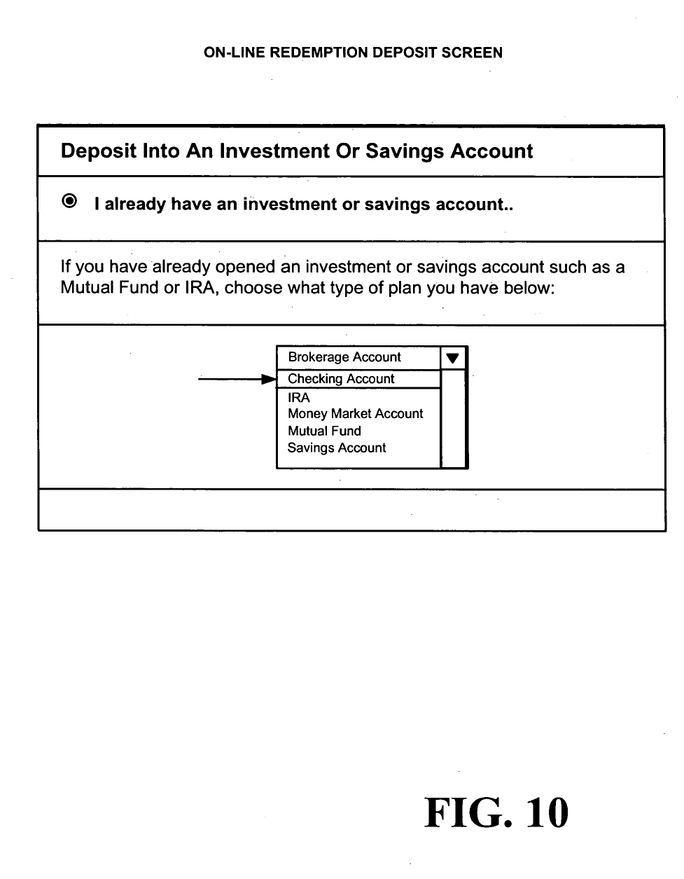

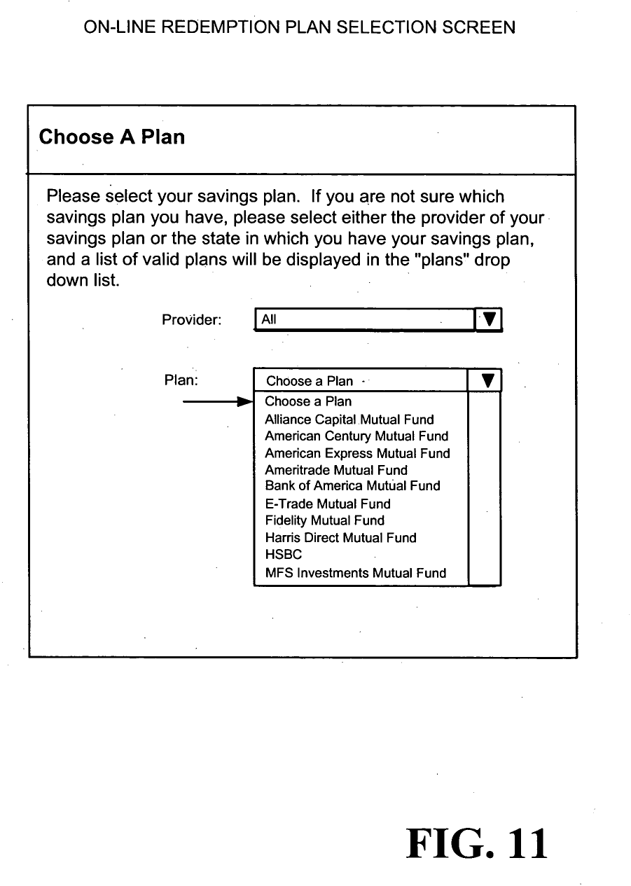

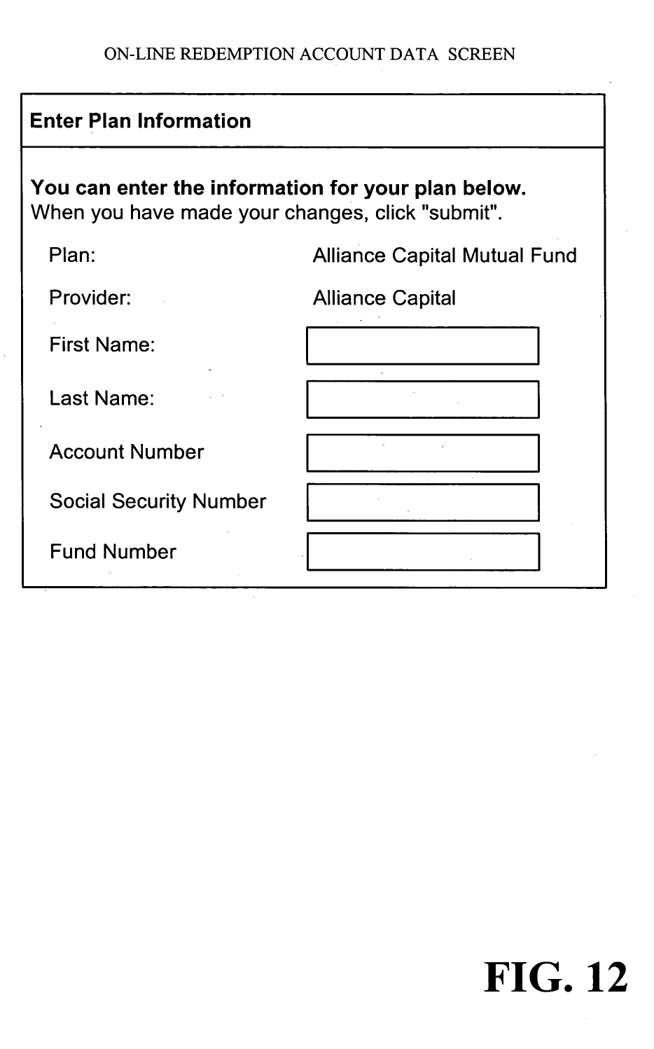

Reference is now made to FIGS. 9-12, which illustrate sample screens of an embodiment of an on-line redemption process. FIG. 9 illustrates a screen permitting the recipient member to select account payout options. FIG. 10 illustrates a screen for the recipient member to select the type of account in which the certificate deposit is to be directed. FIG. 11 illustrates a screen permitting the recipient member to select a savings plan in which the certificate deposit is to be directed. FIG. 12 illustrates a screen for the recipient member to enter the plan specific information. It is appreciated that the above screen illustrations are presented merely for the purposes of example and the invention is not limited to this embodiment.

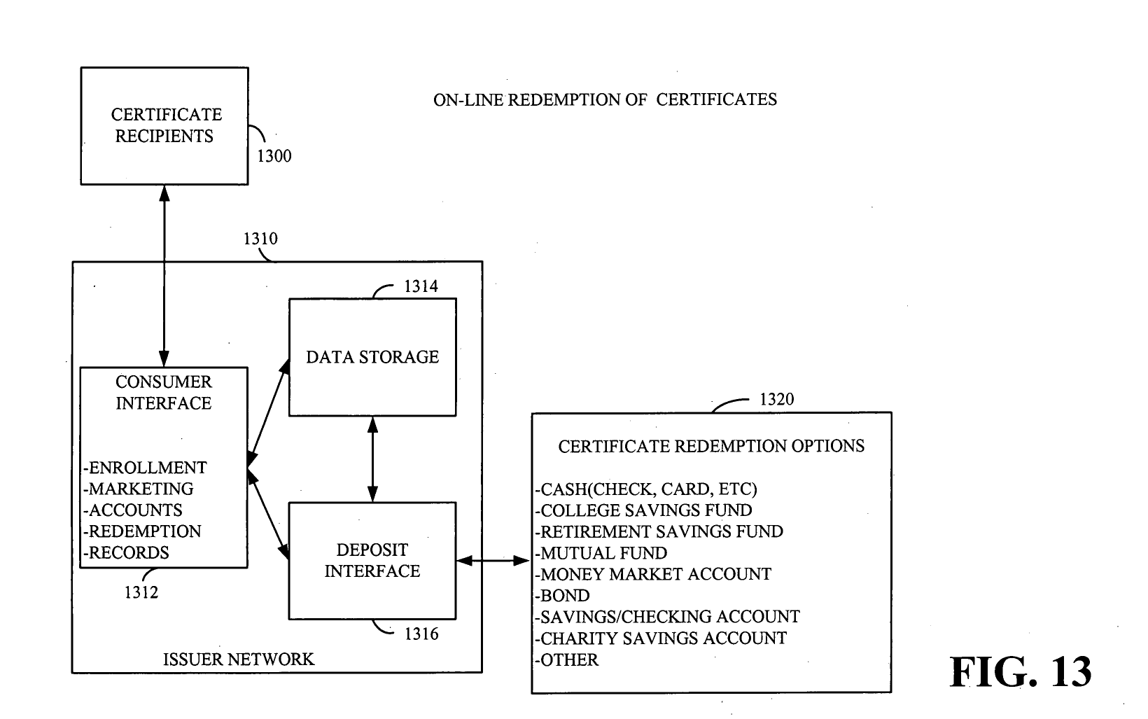

A block diagram of an embodiment of on-line redemption of certificates is shown in FIG. 13. The certificate recipients (block 1300) communicate with the issuer network (block 1310) through a consumer interface (block 1312). A consumer interface includes but is not limited to functionality relating to enrollment, marketing, accounts, redemption and records. A consumer interface communicates with a data storage unit (block 1314) and a deposit interface (block 1316). It will be appreciated that a data storage unit may include one or more electronic devices capable of processing, storing and communicating data. The deposit interface, in coordination with a data storage unit and a consumer interface, facilitates the certificate redemption options (block 1320). These options include, but are not limited to, cash, college savings fund, retirement savings fund, mutual fund, money market account, a bond, savings account, checking account, charity savings account and any other financial vehicle.

To further illustrate the invention, several examples are provided below. Dollars and sample currencies are used in the examples, but other currencies may also be used according to the invention, including currencies supported by other national governments and/or loyalty program points or airline miles which can be assigned a dollar amount for purposes of redemption. Also, the amounts given here are merely illustrative; other numbers may also be used in particular embodiments. It will be realized that the following are specific examples and are not meant to be comprehensive. The following are merely examples and are not intended to limit the scope of systems and methods for promoting savings through a computer-enabled certificate program

### EXAMPLE 1

Consumer A earns airline miles through their participation in Company X's frequent flyer program. Company X utilizes the systems and methods herein described to enable the participants of their loyalty program to transfer airline miles as deposits into their college savings account, retirement account, other savings vehicle for themselves or another party, or as a charitable contribution. For the purposes of this program Company X assigns a conversion value of $0.01 per mile. Company markets to consumers that they can now redeem Company X airline miles for savings. Consumer A is able to convert 10,000 airline miles (points), at a predetermined conversion rate of $0.01 per point, for a $100 Savings Contribution. In the alternative, instead of allowing conversion only in set predetermined increments (10,000 for $100) Company X could use the conversion rate to calculate the certificate value based on the number of miles. In order to make the conversion, Consumer A logs into a specified website (or somehow accesses an electronic interface for loyalty point conversions) and chooses to convert the points into a savings vehicle. Consumer A chooses the number of miles he wishes to redeem and is presented with a unique identifier, or certificate containing a unique serial number, along with instructions on how to complete the redemption process. The serial number provided to the Consumer is tied to a record in a database, which indicates relevant transaction information such as the value of the certificate, date of transaction, as well as pertinent purchaser information. The next step in the redemption process will be for Consumer A, or someone on Consumer A's behalf, to use this serial number/identifier to direct the converted points into a savings vehicle or charitable organization of his choice. Consumer A logs into the savings redemption website, or other electronic interface, and enters his certificate identification number. The system then matches the identifier number to the record in the database and indicates that Consumer A, in this example, has $100 to direct to the investment of his choice. In addition to the on-line redemption process, the savings certificates can be redeemed by calling a designated customer service phone number and providing the representatives with the serial number on the certificate and the savings vehicle to receive the funds. Consumer A is then presented with the option to direct the $100 to any savings vehicle contained in the database, or to type one free-from. In this example, Consumer A selects a mutual fund, and chooses the mutual fund option from a list of possible savings vehicle types. Once Consumer A chooses the mutual fund savings vehicle type, he is prompted to choose the financial institution his mutual fund is with, and then to enter his plan information, including account number. After entering the details of his mutual fund, Consumer A confirms that he would like to make the deposit and then clicks to enter the information into the database. The $100 will then be directed on behalf of Consumer A into the designated mutual fund.

To make the deposit into Consumer A's mutual fund, first there is a verification process to confirm that Consumer A has the specified account with the specified financial institution. Once the verification process has been completed, the deposit will be made on a periodic basis. The deposit can be made stand alone via check or ACH, or aggregated with other deposits and made in bulk to the financial institution. In this case, a lump sum payment for the amount of the entire list of deposits for that financial institution will accompany the electronic file. The financial institution will be responsible for the deposit of funds into the account holder's investment account for the amounts specified. Consumer A may then see the conversion of loyalty points for the deposit amount into the investment on his on-line statement. Additionally, Consumer A will be able to see the deposit amount on his account statement from the financial institution.

### EXAMPLE 2

Consumer B purchases a savings certificate at a gift store location. Each certificate contains a unique identifier that is tied to a record in the database and is preloaded with a specified value such as $25, $50, $100, $250 and $500. The consumer purchases a certificate for $50 plus a possible fulfillment fee and plans to give it as a gift. At the time of purchase certain details of the transaction may be captured related to the certificate purchase into the on-line system, including the unique serial number identifier, date, purchaser, and amount information.

The consumer gives the certificate as a gift to Recipient C. Recipient C follows the directions on the certificate to go to the Savings Certificate website to redeem the certificate. Recipient C registers on the website and enters the serial number identifier for the certificate. The certificate is matched against the database to confirm the amount to the certificate. The certificate match is confirmed for the $50. Recipient C chooses to have the $50 deposited in Financial Institution X's IRA account. Recipient C enters the account number, fund number, and other relevant information, which could include his social security number, phone number, and address. The Recipient then will receive a confirmation in his on-line statement for the redemption of the savings certificate as a contribution of $50 to the IRA account.

### EXAMPLE 3

Savings certificates could be offered by one party as a reward or gift. For example, the certificates could be issued by an investment company at a marketing event such as a trade show. In this example, individuals would be asked to fill out a form for free financial advice and as an incentive would receive a savings certificate that can be redeemed for a $100 deposit into any type of investment account with the issuing financial institution. In this example the issuing party would purchase a stock of the certificates from an issuing entity. The issuing party would be able to distribute the certificates to potential customers at their own discretion. Similar to the example 1, the recipient of the certificate can go to the certificate redemption website or call a designated customer service line and redeem the certificate. In this case the certificate would be designated only for deposit into the issuing party's designated investment account.

### EXAMPLE 4

As in example 1, Consumer A decides to contribute the amount of the certificate to a mutual fund. However, upon logging into the redemption website he finds that the mutual fund he would like the funds deposited into is not listed. In this case, Consumer A would fill out an on-line request form with the name of the financial institution, the account type, the account number, and the address of the financial institution. The information provided would be verified by customer service representatives and then the account type and financial institution would be added to the database and the funds would be deposited according to Consumer A's specifications.

### EXAMPLE 5

Another use of the certificates is as an employee reward or bonus that could be given by employers. In this example Company Z decides to give out savings certificates as employee gifts. Company Z purchases 100 savings certificates from the issuing party. The savings certificates can be uniformly valued (all have $50 or some other value pre-loaded), or Company Z can choose to purchase 50 $100 certificates and 50 $50 certificates, or any other value combination. In this example, Company Z elects to give all employees the same value certificate, and purchases a stock of 100 certificates, all with $50 values. The Company orders the certificates in paper form and each certificate includes the unique identifier number which will indicate the value of the certificate, as well as pertinent purchaser and recipient information, and the instructions on how to redeem the certificates. In this case, the employees each receive a $50 certificate and then can choose how they would like to deposit the funds, or to receive a check for the amount of the certificate.

### EXAMPLE 6

Another use for the savings certificates is as an employee incentive. Instead of rewarding an employee for commendable performance with a monetary gift, a Company could reward the employee with a savings certificate, which can be invested as the employee chooses. For example, suppose Employee A signs a big deal for Company X and to show their appreciation for Employee A's hard work and dedication to the company, Company X gives Employee A a savings certificate for $1000. The employee will receive the certificate indicating the amount and the number unique identifier and he will be able to redeem the certificate for deposit into his existing investment account. The employee may alternatively decide to open a new account to receive the funds.

### EXAMPLE 7

Additionally, the certificates could be used as a fundraising tool for non-profit organizations. The non-profit organizations could sell the certificates to individuals to give as gifts. For example, Consumer C can purchase a certificate for $25 for a donation to Non-Profit Organization E to give as a gift to Recipient D. Recipient D would receive the certificate that the $25 was contributed to Non-Profit E on his behalf by Consumer C. Non-profit organizations could sell the certificates in fundraising campaigns.

As an extension of this example, Consumer C could also purchase a certificate that could be used as a contribution to any charity or non-profit organization. In this case, Consumer C would purchase the certificate for a specific amount and give it to Recipient D. Recipient D would receive the certificate explaining that Consumer C has given him the certificate for him to donate to the charity of his choice. Recipient D then logs into the redemption website and chooses the organization he would like the funds contributed to from a listing of possible organizations. If Recipient D's organization was not listed, he could request that it be added to the database and provide the address and non-profit identification numbers. Once the non-profit is confirmed and added to the database, the funds can be directed according to Recipient D's direction.

It should be emphasized that the above-described are merely possible examples of implementations. It will be realized that many variations of the above-described examples are possible.

Embodiments of promoting savings through use of a computer-enabled certificate program can be implemented in hardware, software, firmware, or a combination thereof. Elements implemented in software or firmware can be stored in a memory and executed by a suitable instruction execution system. Elements implemented in hardware can be implemented with any or a combination of the following technologies, which are all well known in the art: a discrete logic circuit(s) having logic gates for implementing logic functions upon data signals, an application specific integrated circuit(s) (ASIC) having appropriate combinational logic gates, a programmable gate array(s) (PGA), a field programmable gate array(s) (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Certain elements of the computer enabled certificate program can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

Therefore, having thus described the invention, at least the following is claimed:

1. A system for promoting savings by enabling a consumer through at least one covered electronic transaction to convert loyalty points or other currency for a direct deposit into a savings vehicle, said system comprising:
an agreement with a consumer, wherein certain points are converted into a value, wherein the certain points are converted at a conversion rate, wherein the conversion rate is determined by the agreement, wherein the value is deposited;
a plurality of electronic data processing devices, wherein each of the plurality of electronic data processing devices is configured to communicate electronic data with at least one other of the plurality of electronic data processing devices, wherein the electronic data comprises information relating to a certificate;
a first electronic data processing device of the plurality of electronic data processing devices, further configured to transmit purchase data to a second electronic data processing device of the plurality of electronic data processing devices, wherein the purchase data comprises payment method data, wherein the purchase data further comprises consumer data, wherein the purchase data further comprises purchaser data, wherein the purchase data further comprises a certificate value;
the second electronic data processing device, further configured to receive the purchase data, wherein the second electronic data processing device is further configured to enter an order, wherein the order is stored in an electronic database, wherein the second electronic data processing device is further configured to generate a unique transaction identifier, wherein the second electronic data processing device is further configured to create a certificate data record, wherein the certificate data record is stored in an electronic customer database, wherein the certificate data record is transmitted to a third electronic data processing device of the plurality of electronic data processing devices;
the third electronic data processing device, further configured to receive the certificate data record; wherein the third electronic data processing device is further configured to transmit the certificate data record to a fourth electronic data processing device of the plurality of electronic data processing devices for the purpose of redeeming the certificate data record; wherein the third electronic data processing device is further configured to transmit account data; where the account data identifies how the certificate value is directed;
the fourth electronic data processing device, further configured to receive the certificate data record and the account data; wherein the fourth electronic data processing device is further configured to create the account for a new consumer; wherein the fourth electronic data processing device is further configured to deposit the certificate value into a financial institution.

2. A method for implementing an on-line certificate program, comprising the steps of:
marketing a certificate program;
receiving a purchase request for a certificate;
processing the purchase request for the certificate;
issuing the certificate; and
redeeming the certificate.

3. The method of claim 2, wherein the step of redeeming the certificate comprises adding value to an account; wherein the account is designated by a certificate recipient.

4. The method of claim 3, wherein the certificate further comprises an electronic certificate, wherein the step of issuing the electronic certificate is performed electronically.

5. The method of claim 4, wherein the electronic certificate further comprises a link to a networked computer; wherein the networked computer is configured to perform the step of redeeming the electronic certificate.

6. The method of claim 5, further comprising the step of creating a transaction record, wherein the transaction record further comprises a unique serial number.

7. The method of claim 6, wherein the unique serial number comprises information content relating to the identity of the person redeeming the certificate, wherein the unique serial number further comprises information content relating to the date of issuance of the certificate; wherein the unique serial number further comprises information content relating to the date the redemption of the certificate; wherein the unique serial number further comprises information content relating to the identity of the purchaser of the certificate.

8. The method of claim 3, wherein the certificate comprises a paper certificate, wherein the step of issuing the paper certificate comprises the step of creating an electronic certificate transaction record; wherein the step of issuing the paper certificate further comprises transmitting the electronic transaction record to a printing facility.

9. The method of claim 8, wherein the step of redeeming the certificate further comprising the steps of:
establishing a communication link with an issuer;
communicating data relating to the certificate; and
crediting the account with the value of the certificate.

10. The method of claim 9, wherein the communication link is selected from the group consisting of telephonic, computer network and physical delivery.

11. The method of claim 10, further comprising the step of creating a transaction record, wherein the transaction record further comprises a unique serial number.

12. The method of claim 11, wherein the unique serial number comprises information content relating to the identity of the person redeeming the certificate, wherein the unique serial number further comprises information content relating to the date of issuance of the certificate; wherein the unique serial number further comprises information content relating to the date the redemption of the certificate; wherein the unique serial number further comprises information content relating to the identity of the purchaser of the certificate.

13. The method of claim 3, wherein the step of marketing the certificate program further comprises the step of directly soliciting business entities to participate in the certificate program.

14. The method of claim 3, wherein the step of marketing the certificate program further comprises the step of establishing a network of marketing agencies; wherein the marketing agencies resell the certificates.

15. A computer readable medium having a computer program for implementing a certificate program, the computer program for performing the steps of:
receiving an order to purchase a certificate, wherein the certificate comprises a monetary value;
processing the order to purchase the certificate;
issuing the certificate;
redeeming the certificate; and
depositing the monetary value into an account.

16. The computer readable medium as set forth in claim 15, wherein the step of receiving an order to purchase a certificate further comprises the steps of:
receiving identification data relating to a purchaser;
receiving identification data relating to a recipient;
receiving data relating to the monetary value;
receiving financial data relating to payment for the certificate; and
generating a certificate transaction.

17. The computer readable medium as set forth in claim 16, wherein the step of processing the order to purchase the certificate further comprises the step of
creating a transaction record, wherein the transaction record further comprises a unique serial number.

18. The computer readable medium as set forth in claim 17, wherein the step of issuing the certificate comprises the step of transmitting the certificate directly to the recipient, wherein the certificate is transmitted electronically to a computer.

19. The computer readable medium as set forth in claim 17, wherein the step of issuing the certificate comprises the step of transmitting the certificate transaction to a certificate printing facility; wherein the certificate printing facility transmits a printed certificate directly to the recipient.

20. The computer readable medium as set forth in claim 17, wherein the step of redeeming the certificate comprises a step selected from the group of: establishing a computer link, wherein the computer link is established via an internet website; communicating via telephone; and transmitting a printed certificate to the issuer.

21. The computer readable medium as set forth in claim 20, wherein the step of depositing the monetary value into an account further comprises the step of transmitting the monetary value to an existing account, wherein the account is designated by the recipient.

22. The computer readable medium as set forth in claim 20, wherein the step of depositing the monetary value into an account further comprises the steps of:
creating the account, wherein the account is designated by the recipient; and
transmitting the monetary value to the account.

23. An electronic device for processing and managing a certificate program for increasing the value of a recipient designated account, the device comprising:
a receiving unit for receiving a purchase request for a certificate;
a processing unit for processing the purchase request;
an issuing unit for issuing the certificate, wherein the certificate comprises a monetary value;
an account creating unit for creating an account; and
a redemption unit for redeeming the certificate; wherein the redemption unit is configured to deposit the monetary value into the recipient designated account.

24. A method for processing an on-line certificate program, the method comprising the steps of:
purchasing a certificate;
issuing the certificate, wherein the certificate is transmitted to a recipient;
redeeming the certificate for a monetary value; and
directing the monetary value to a savings vehicle, wherein the savings vehicle is selected by the recipient.

25. The method of claim 24, wherein the step of purchasing the certificate further comprises converting award program loyalty points, wherein the award program loyalty points are assigned a currency value, wherein the currency value corresponds to the monetary value of the certificate.

26. The method of claim 25, wherein the savings vehicle is selected from the group consisting of a savings account, a college savings account, a retirement savings account, a mutual fund, a certificate of deposit, a money market account and a brokerage account.

27. The method of claim 24, wherein the step of purchasing the certificate further comprises receiving a payment.

28. The method of claim 27, wherein the payment is selected from the group consisting of cash, credit account, credit card, and check.

29. The method of claim 28, wherein the savings vehicle is selected from the group consisting of a savings account, a college savings account, a retirement savings account, a mutual fund, a certificate of deposit, a money market account and a brokerage account.

30. The method of claim 24, wherein the step of redeeming the certificate further comprises designating an organization, wherein the organization comprises a non-profit organization.

31. The method of claim 24, wherein the step of purchasing the certificate is performed by an individual.

32. The method of claim 24, wherein the step of purchasing the certificate is performed by a business organization.

33. The method of claim 32, wherein the business organization purchases the certificates to provide an employee benefit.
